(19) United States
(12) Patent Application Publication
(10) Pub. No.: US 2024/0329810 A1
(43) Pub. Date: Oct. 3, 2024

(54) INFORMATION PROCESSING SYSTEM, NON-TRANSITORY COMPUTER READABLE MEDIUM, AND METHOD

(71) Applicant: FUJIFILM Business Innovation Corp., Tokyo (JP)

(72) Inventor: Makoto YOSHIMI, Kanagawa (JP)

(73) Assignee: FUJIFILM Business Innovation Corp., Tokyo (JP)

(21) Appl. No.: 18/456,517

(22) Filed: Aug. 27, 2023

(30) Foreign Application Priority Data
Mar. 28, 2023 (JP) 2023-052411

(51) Int. Cl. G06F 3/0484

(52) U.S. Cl. CPC G06F 3/0484

(57) ABSTRACT

An information processing system includes: a processor or multiple processors configured to: generate a screen that includes a second object in which predetermined information is written in a second language, based on information about a first object in which the predetermined information is written in a first language, the first object being included in an operation screen of an image processing apparatus; and display an operation button for superposing the screen that includes the second object on the operation screen in response to displaying the operation screen that includes the first object on the image processing apparatus that is remotely operated.

### CROSS-REFERENCE TO RELATED APPLICATIONS

This application is based on and claims priority under 35 USC 119 from Japanese Patent Application No. 2023-052411 filed Mar. 28, 2023.

### BACKGROUND

### (i) Technical Field

The present disclosure relates to an information processing system, a non-transitory computer readable medium, and a method.

### (ii) Related Art

A known technique enables an image processing apparatus such as a so-called multifunction peripheral that is capable of, for example, printing and reading documents to be remotely operated by a mobile terminal (for example, Japanese Unexamined Patent Application Publication No. 2019-200472). As for such a technique, an operation screen of the image processing apparatus is shared with the mobile terminal. For example, in the case where the language setting of the operation screen of the image processing apparatus is changed by a remote operation, the operation screen after the change is shared.

### SUMMARY

However, the image processing apparatus cannot perform any operation during the remote operation, and accordingly, the image processing apparatus cannot undo the language setting. For this reason, for example, in some cases where the language setting of the operation screen is changed even when information such as a message that represents “out of paper” to be reported to a person near the image processing apparatus is displayed on the operation screen, the person near the image processing apparatus cannot understand the information that is displayed on the operation screen.

Aspects of non-limiting embodiments of the present disclosure relate to enabling a person near an image processing apparatus to understand information that is displayed on an operation screen even in the case where the language setting of the operation screen of the image processing apparatus is changed by a remote operation.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor or a plurality of processors configured to: generate a screen that includes a second object in which predetermined information is written in a second language, based on information about a first object in which the predetermined information is written in a first language, the first object being included in an operation screen of an image processing apparatus; and display an operation button for superposing the screen that includes the second object on the operation screen in response to displaying the operation screen that includes the first object on the image processing apparatus that is remotely operated.

### BRIEF DESCRIPTION OF THE DRAWINGS

Exemplary embodiments of the present disclosure will be described in detail based on the following figures, wherein:

FIG. 1 illustrates an example of the entire configuration of an information processing system according to the exemplary embodiments;

FIG. 2 illustrates an example of the hardware configuration of an image processing apparatus;

FIG. 3 illustrates an example of the functional configuration of a controller in the image processing apparatus;

FIG. 4 illustrates an example of the functional configuration of a controller in a remote terminal;

FIG. 5 is a flowchart illustrating the overall flow of the processing of the image processing apparatus;

FIG. 6 is a flowchart illustrating the flow of a mask generation process that is included in the processing of the image processing apparatus;

FIG. 7A illustrates a specific example of an operation screen of the image processing apparatus that is displayed on and shared with the remote terminal;

FIG. 7B illustrates a specific example of the operation screen of the image processing apparatus that is displayed on the image processing apparatus;

FIG. 8 illustrates a situation in which a mask screen that includes a second object that is written in a second language is superposed on an operation screen that includes a first object that is written in a first language; and

FIG. 9 illustrates a specific example of a clear button for clearing the mask screen that is displayed.

### DETAILED DESCRIPTION

An exemplary embodiment of the present disclosure will hereinafter be described in detail with reference to the attached drawings.

### Structure of Information Processing System

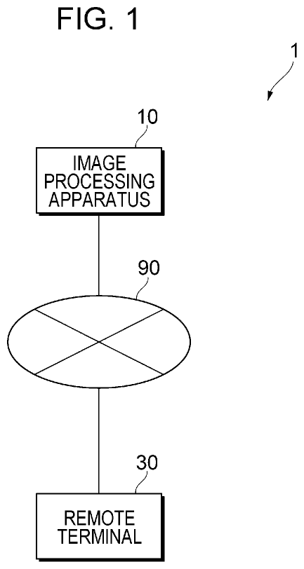

FIG. 1 illustrates an example of the entire configuration of an information processing system 1 according to the present exemplary embodiment.

The information processing system 1 includes an image processing apparatus 10 and a remote terminal 30 that are connected to each other with a network 90 interposed therebetween. Examples of the network 90 include a local area network (LAN) and the internet.

### Image Processing Apparatus

The image processing apparatus 10 is an information processing apparatus that performs various kinds of processing in response to an input operation of a user who uses the information processing system 1. For example, the image processing apparatus 10 performs a process of forming an image on a medium such as paper, a process of outputting a recording medium on which an image is formed, and a process of reading an image that is formed on, for example, paper. Examples of the image processing apparatus 10 include a so-called electrophotographic multifunction peripheral that forms a toner image on a print surface of paper and a so-called ink-jet printer that discharges ink to a print surface of paper.

The image processing apparatus 10 acquires various kinds of information that the remote terminal 30 transmits and performs various kinds of processing. The image processing apparatus 10 transmits various kinds of information to the remote terminal 30. For example, the image processing apparatus 10 performs a process of generating a mask screen that includes a second object in which predetermined information is written in a second language, based on a first object in which the predetermined information is written in a first language where the first object is included in the operation screen of the image processing apparatus 10.

The mask screen is generated in a manner in which a transparent region is used as a base, and an opaque object region is placed. The mask screen is placed so as to be superposed on the operation screen and functions as a cover such that a region of the operation screen is visible through the transparent region, and a region of the operation screen is invisible through the opaque object region. The mask screen is generated for every kind of the second language. The image processing apparatus 10 stores and manages the generated mask screen in a database.

An example of the “predetermined information” described herein is information (referred to below as “user report information”) that is reported to the user. An example of the user report information is information with which another user near the image processing apparatus 10 needs to deal such as an “operation guide for refilling paper” and an “operation guide for replacing a toner cartridge”. In the following description, the “predetermined information” that is displayed on the operation screen is the “user report information” and the information with which the other user near the image processing apparatus 10 needs to deal.

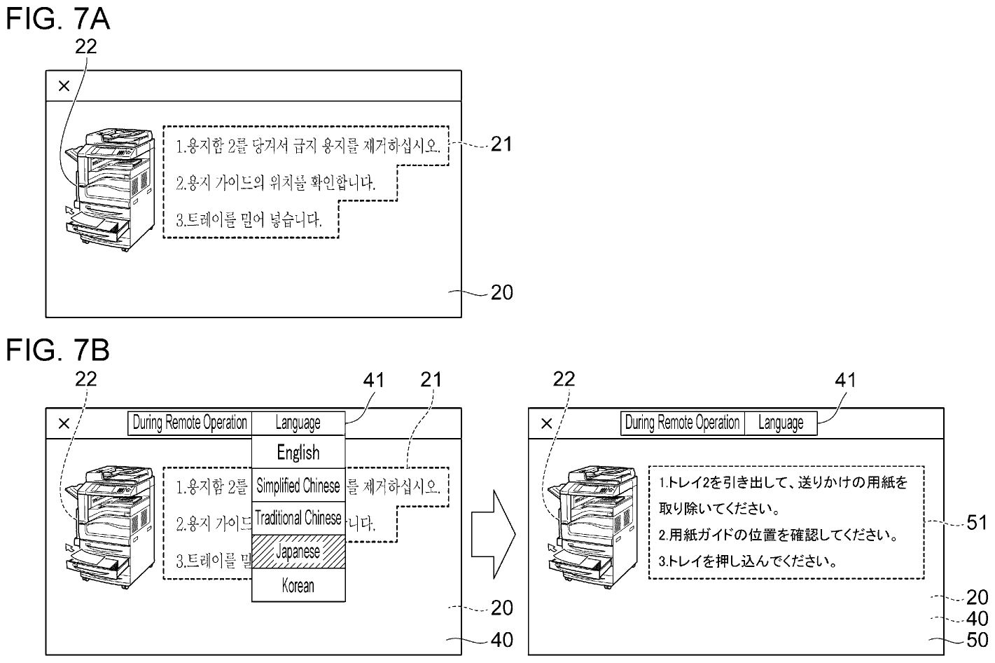

The image processing apparatus 10 begins to perform the process of generating the mask screen by identifying the position, character color, background color, shape, and size of the first object that is displayed on the operation screen of the image processing apparatus 10, and the user report information is written in the first language in the first object. Subsequently, the image processing apparatus 10 generates the second object in which the user report information is written in the second language, based on the identified position, character color, background color, shape, and size of the first object. The image processing apparatus 10 generates the mask screen on which the second object is placed at a position at which the second object entirely covers the first object. A specific example of the generated mask screen will be described later with reference to FIG. 7A to FIG. 9.

The image processing apparatus 10 displays the operation screen in response to a remote operation that is performed by the remote terminal 30 on the image processing apparatus 10. At this time, the operation screen of the image processing apparatus 10 is shared with the remote terminal 30. An operation on the operation screen that is displayed on the remote terminal 30 is accepted as an operation on the operation screen of the image processing apparatus 10. For example, the language setting of the operation screen that is shared between the image processing apparatus 10 and the remote terminal 30 is the second language, and a user who operates the remote terminal 30 uses the first language.

In this case, the user who operates the remote terminal 30 may change the language setting of the remote terminal 30 from the second language into the first language. Text data that is displayed on the remote terminal 30 is changed from the second language into the first language in response to the change in the language setting of the remote terminal 30 from the second language into the first language. In addition, text data that is displayed on the image processing apparatus 10 that shares the operation screen is changed from the second language into the first language. At this time, the image processing apparatus 10 displays an operation button for superposing the mask screen described above on the operation screen that is displayed on the image processing apparatus 10. A specific example of the operation button for superposing the mask screen on the operation screen will be described later with reference to FIG. 7A to FIG. 9.

In a case, information with which another user near the image processing apparatus 10 needs to deal is displayed as the user report information on the operation screen of the image processing apparatus 10. In this case, the user report information that is written in the first language is displayed on the operation screen of the image processing apparatus 10. For this reason, in some cases where the other user who views the operation screen of the image processing apparatus 10 uses the second language, the other user cannot understand the content of the user report information that is written in the first language on the operation screen of the image processing apparatus 10.

In these cases, the other user who views the operation screen of the image processing apparatus 10 pushes the operation button for superposing the mask screen on the operation screen. In response to this, the image processing apparatus 10 displays the mask screen that is superposed on the operation screen of the image processing apparatus 10. The mask screen that is thus superposed on the operation screen includes the second object in which the user report information is written in the second language. The second object entirely covers the first object. For this reason, the other user who views the operation screen of the image processing apparatus 10 is able to understand the user report information that is displayed on the operation screen in the second language.

The image processing apparatus 10 clears the mask screen that is displayed when a predetermined time has passed after the mask screen starts to be displayed. The image processing apparatus 10 clears the mask screen that is displayed in response to an operation of pushing a clear button for clearing the mask screen that is displayed before the predetermined time has passed after the mask screen starts to be displayed. The mask screen that is displayed is cleared, and the operation screen of which the language setting is set at the first language is consequently displayed again. The processing of the image processing apparatus 10 will be described in detail later.

### Remote Terminal

The remote terminal 30 is a mobile information processing apparatus such as a smart phone or a tablet terminal that is operated by the user who uses the information processing system 1. Application software that enables the image processing apparatus 10 to be operated is installed in the remote terminal 30. The remote terminal 30 acquires various kinds of information transmitted from the image processing apparatus 10 and performs various kinds of processing. The remote terminal 30 transmits various kinds of information to the image processing apparatus 10. For example, the remote terminal 30 acquires the data of the operation screen of the image processing apparatus 10 and displays the operation screen that is shared. The remote terminal 30 receives information that is inputted to change the language setting of the operation screen that is shared and transmits the inputted information to the image processing apparatus 10. The processing of the remote terminal 30 will be described in detail later.

The structure of the information processing system 1 is described above by way of example. The information processing system 1 as a whole has a function of performing the processing described above. For this reason, the information processing system 1 may perform a part or the whole of the function of performing the processing described above by itself or in cooperation. That is, the function of the image processing apparatus 10 may include a part or the whole of the function of the remote terminal 30, or the function of the remote terminal 30 may include a part or the whole of the function of the image processing apparatus 10. Parts or the whole of the functions of the remote terminal 30 and the image processing apparatus 10 that are included in the information processing system 1 may be delegated to, for example, a server not illustrated. In this way, the processing of the information processing system 1 as a whole may be facilitated or complemented.

### Hardware Configuration of Image Processing Apparatus

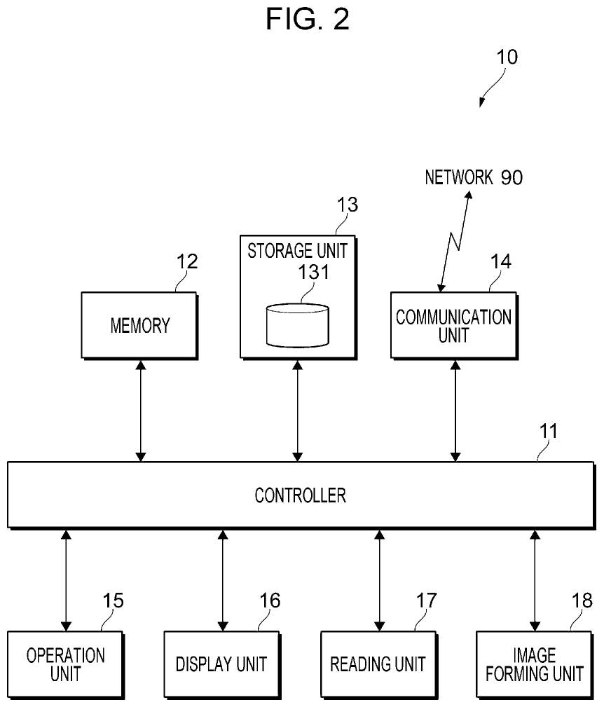

FIG. 2 illustrates an example of the hardware configuration of the image processing apparatus 10.

The image processing apparatus 10 includes a controller 11, a memory 12, a storage unit 13, a communication unit 14, an operation unit 15, a display unit 16, a reading unit 17, and an image forming unit 18. These components are connected by using, for example, a data bus, an address bus, and a peripheral component interconnect (PCI) bus.

The controller 11 is a processor that controls the function of the remote terminal 30 by running various kinds of software such as a basic software (an OS) and application software. For example, the controller 11 includes a central processing unit (CPU). The memory 12 has a storage area in which various kinds of software and data that is used for running the software, for example, are stored and is used as a work area during arithmetic processing. For example, the memory 12 includes a random access memory (RAM).

The storage unit 13 has a storage area in which input data into various kinds of software and output data from various kinds of software, for example, are stored. Examples of the storage unit 13 include a hard disk drive (HDD), a solid state drive (SSD), and a semiconductor memory that are used to store a program and various kinds of setting data. The storage unit 13 includes a database that stores various kinds of information, and an example thereof is a mask screen DB 131 that stores a mask screen.

The communication unit 14 transmits data to the remote terminal 30 and the outside and receives data therefrom via the network 90. For example, the operation unit 15 includes a software keyboard, a mechanical button, and/or a switch and accepts an input operation. The operation unit 15 also includes a touch sensor that includes a touch screen that is integrally formed with the display unit 16. For example, the display unit 16 includes a liquid-crystal display or an organic electro-luminescence (EL) display that is used to display information and displays the data of a text and an image.

The reading unit 17 reads an image that is recorded on a medium (for example, a document of a paper medium) such as paper corresponding to the recording medium. For example, the reading unit 17 includes a CCD scanner that reduces reflected light concerning light radiated from a light source to a document by using a lens and that receives the reflected light by using a charge coupled device (CCD), or a CIS scanner that receives reflected light concerning light that is radiated from a LED light source to a document by using a contact image sensor (CIS). The image forming unit 18 forms an image to be printed on a print surface of paper corresponding to the recording medium by using, for example, an electrophotographic system or an ink-jet system. These components are connected by using, for example, a data bus, an address bus, and a PCI bus.

### Hardware Configuration of Remote Terminal

The hardware configuration of the remote terminal 30 is the same as the hardware configuration of the image processing apparatus 10 illustrated in FIG. 2 except for the reading unit 17 and the image forming unit 18. That is, the remote terminal 30 includes a controller, a memory, a storage unit, a communication unit, an operation unit, and a display unit that have the same functions as the functions of the controller 11, the memory 12, the storage unit 13, the communication unit 14, the operation unit 15, and the display unit 16 in FIG. 2, and these are not illustrated or described.

### Functional Configuration of Controller of Image Processing Apparatus

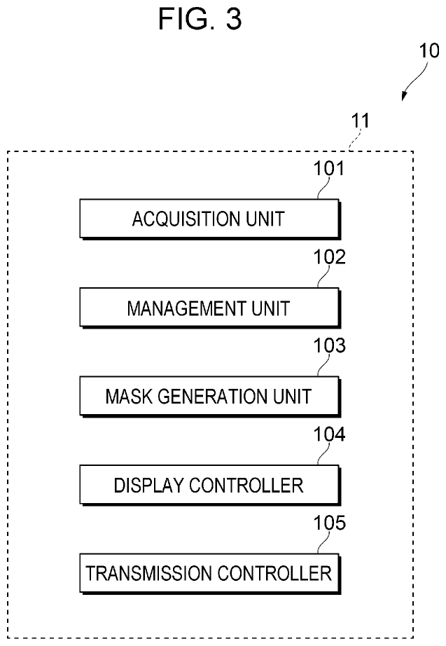

FIG. 3 illustrates an example of the functional configuration of the controller 11 of the image processing apparatus 10.

As for the controller 11 of the image processing apparatus 10, an acquisition unit 101, a management unit 102, a mask generation unit 103, a display controller 104, and a transmission controller 105 function.

The acquisition unit 101 acquires various kinds of information. For example, the acquisition unit 101 acquires input information that is received by the operation unit 15 (see FIG. 2) of the image processing apparatus 10. For example, the acquisition unit 101 acquires various kinds of information transmitted from the remote terminal 30 and the outside. An example of the information that is transmitted from the remote terminal 30 in the information that is acquired by the acquisition unit 101 is input information that is inputted into the remote terminal 30. An example of the input information that is acquired by the acquisition unit 101 is information that is inputted into the remote terminal 30 to change the language setting of the operation screen that is shared.

The management unit 102 manages various kinds of information that the database of the storage unit 13 (see FIG. 2) stores. For example, the management unit 102 manages the mask screen that is generated by the mask generation unit 103 described later and that is stored in the mask screen DB 131.

The mask generation unit 103 performs the process of generating the mask screen. Specifically, the mask generation unit 103 identifies the position, character color, background color, shape, and size of a text object that is displayed on the operation screen of the image processing apparatus 10 and that corresponds to the first object in which the user report information is written in the first language. Subsequently, the mask generation unit 103 generates a text object that corresponds to the second object in which the user report information is written in the second language, based on the identified position, character color, background color, shape, and size of the text object that corresponds to the first object. The mask generation unit 103 generates the mask screen on which the text object that corresponds to the second object is placed at a position at which the second object entirely covers the text object that corresponds to the first object.

In the description herein, for example, the first language is Korean, the second language is Japanese, and the user report information is the operation guide for refilling paper. In this case, the mask generation unit 103 generates the mask screen that includes the text object that corresponds to the second object in which the operation guide is written in Japanese, based on the text object that corresponds to the first object in which the operation guide that is included in the operation screen of the image processing apparatus 10 is written in Korean.

In this case, the mask generation unit 103 first identifies the position, character color, background color, shape, and size of the text object that is displayed on the operation screen of the image processing apparatus 10 and that corresponds to the first object in which the operation guide for refilling paper is written in Korean. Subsequently, the mask generation unit 103 generates the mask screen that includes the second object that entirely covers the text object, based on the identified position, character color, background color, shape, and size of the text object that corresponds to the first object. Specifically, the mask generation unit 103 generates the mask screen that includes the text object that corresponds to the second object in which the operation guide for refiling paper is written by Japanese.

The display controller 104 implements a control for causing the display unit 16 (see FIG. 2) to display various kinds of information. For example, the display controller 104 implements a control for causing the mask screen and the operation screen of the image processing apparatus 10 to be displayed.

The transmission controller 105 implements a control for transmitting various kinds of information via the communication unit 14 (see FIG. 2). Specifically, the transmission controller 105 implements a control for transmitting various kinds of information to the remote terminal 30 and the outside. For example, the transmission controller 105 implements a control for transmitting the data of the operation screen of the image processing apparatus 10 to the remote terminal 30. The data of the operation screen includes the user report information.

### Functional Configuration of Controller of Remote Terminal

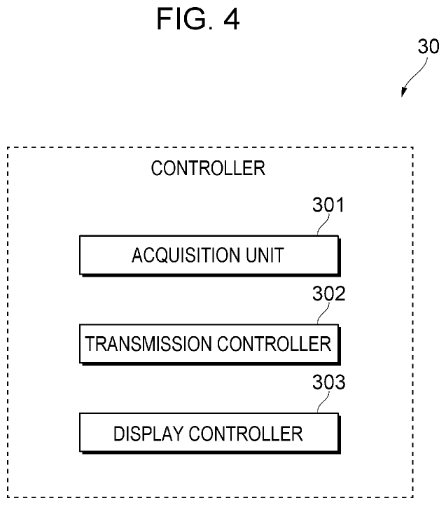

FIG. 4 illustrates an example of the functional configuration of the controller of the remote terminal 30.

As for the controller of the remote terminal 30, an acquisition unit 301, a transmission controller 302, and a display controller 303 function.

The acquisition unit 301 acquires various kinds of information. For example, the acquisition unit 301 acquires input information that is received by the operation unit of the remote terminal 30. For example, the acquisition unit 301 acquires various kinds of information transmitted from the image processing apparatus 10 and the outside. Examples of the information that is transmitted from the image processing apparatus 10 in the information that is acquired by the acquisition unit 301 include the data of the operation screen of the image processing apparatus 10.

The transmission controller 302 implements a control for transmitting various kinds of information via the communication unit. Specifically, the transmission controller 302 implements a control for transmitting various kinds of information to the image processing apparatus 10 and the outside. For example, the transmission controller 302 implements a control for transmitting the input information that is acquired by the acquisition unit 301 to the image processing apparatus 10. Examples of the input information that is transmitted to the image processing apparatus 10 include information that is inputted to change the language setting of the operation screen that is shared.

The display controller 303 implements a control for causing the display unit to display various kinds of information. For example, the display controller 303 implements a control for causing the display unit to display the operation screen of the image processing apparatus 10 that is shared.

### Flow of Processing

### Flow of Processing of Image Processing Apparatus

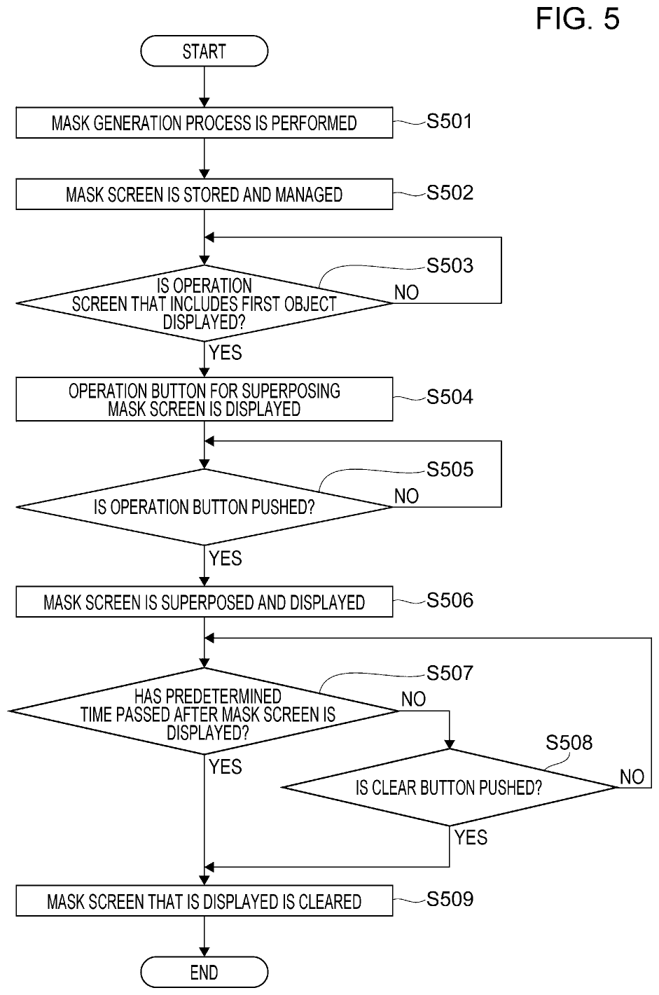

FIG. 5 is a flowchart illustrating the overall flow of the processing of the image processing apparatus 10. In an example in FIG. 5, the user report information that is included in the operation screen of the image processing apparatus 10 is information with which another user near the image processing apparatus 10 needs to deal.

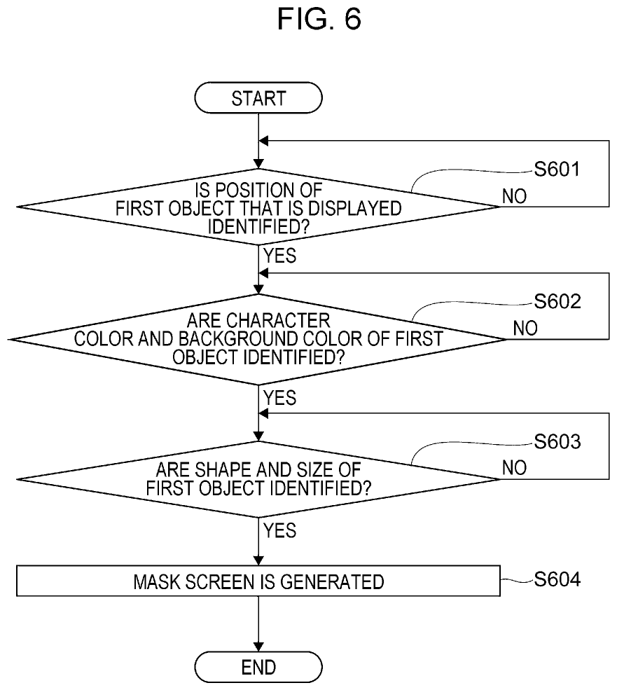

The image processing apparatus 10 performs a mask generation process of generating the mask screen that includes the second object in which the user report information is written in the second language, based on the first object in which the user report information is written in the first language where the first object is included in the operation screen of the image processing apparatus 10 (a step 501). The flow of the mask generation process will be described later with reference to a flowchart in FIG. 6. The image processing apparatus 10 stores and manages the mask screen that is generated at the step 501 (a step 502).

The image processing apparatus 10 displays the operation button for superposing the mask screen on the operation screen (a step 504) in response to displaying the operation screen that includes the first object in response to the remote operation performed by the remote terminal 30 (YES at a step 503). In the case where the operation screen that includes the first object is not displayed (NO at the step 503), however, the image processing apparatus 10 repeats a process of determination at the step 503 until the operation screen that includes the first object is displayed.

The image processing apparatus 10 displays the mask screen that is superposed on the operation screen (a step 506) in response to the operation of pushing the operation button that is displayed at the step 504 (YES at a step 505). In the case where the operation button is not pushed (NO at the step 505), however, a process of determination at the step 505 is repeated until the operation button is pushed.

The image processing apparatus 10 clears the mask screen that is displayed (a step 509) when a predetermined time has passed after the mask screen is displayed (YES at a step 507). In the case where the predetermined time has not passed after the mask screen is displayed (NO at the step 507), but the clear button for clearing the mask screen that is displayed is pushed (YES a step 508), the mask screen that is displayed is cleared (the step 509). In the case where the predetermined time has not passed after the mask screen is displayed (NO at the step 507), and the clear button is not pushed (NO at the step 508), however, the image processing apparatus 10 repeats processes of determination at the steps 507 and 508.

FIG. 6 is a flowchart illustrating the flow of the mask generation process that is included in the processing of the image processing apparatus 10.

The image processing apparatus 10 performs a process of determination at a step 602 after the position of the first object that is displayed on the operation screen of the image processing apparatus 10 is identified (YES at a step 601). In the case where the position of the first object that is displayed is not identified (NO at the step 601), the image processing apparatus 10 repeats a process of determination at the step 601 until the position of the first object that is displayed is identified.

The image processing apparatus 10 performs a process of determination at a step 603 after the character color and background color of the first object on the operation screen of the image processing apparatus 10 are identified (YES at the step 602). In the case where the character color and background color of the first object are not identified (NO at the step 602), however, the image processing apparatus 10 repeats the process of determination at the step 602 until the character color and background color of the first object are identified.

The image processing apparatus 10 performs a process at a step 604 after the shape and size of the first object on the operation screen of the image processing apparatus 10 are identified (YES at the step 603). In the case where the shape and size of the first object are not identified (NO at the step 603), however, the image processing apparatus 10 repeats the process of determination at the step 603 until the shape and size of the first object are identified.

The image processing apparatus 10 generates the mask screen that includes the second object that is placed at a position at which the second object entirely covers the first object, based on the identified position, character color, background color, shape and size of the first object that is displayed (the step 604).

### Specific Examples

FIG. 7A illustrates a specific example of the operation screen of the image processing apparatus 10 that is displayed on and shared with the remote terminal 30. FIG. 7B illustrates a specific example of the operation screen of the image processing apparatus 10 that is displayed on the image processing apparatus 10. In the examples illustrated in FIG. 7A and FIG. 7B, the remote terminal 30 is operated to change the language setting from Japanese into Korean. The user report information that is displayed on the operation screen is the operation guide for refilling paper.

As illustrated in FIG. 7A, an operation screen 20 that is displayed on and shared with the remote terminal 30 includes objects 21 and 22. Of the objects, the object 21 is a text object in which the operation guide for refilling paper is written. The object 22 is an object of an image of the image processing apparatus 10 (see FIG. 1). The operation guide is written in Korean in the object 21 because the language setting is changed.

As illustrated in FIG. 7B, a screen 40 (referred to below as an “operation button screen 40”) on which an operation button 41 for superposing the mask screen is placed is superposed on the operation screen 20 that is displayed on the image processing apparatus 10. The operation button screen 40 is generated in a manner in which a transparent region is used as a base, and an opaque operation button region is placed as in the mask screen.

As illustrated in FIG. 7B, the operation button 41 is a button on which words “Language” are written. The kinds of the second language are displayed so as to be selectable in response to an operation of pushing the operation button 41. Specifically, any one of English, Chinese, Japanese, and Korean, for example, may be selected. In the example in FIG. 7B, “Japanese” is selected, and accordingly, a mask screen 50 that includes a text object 51 in which the operation guide is written in Japanese is displayed.

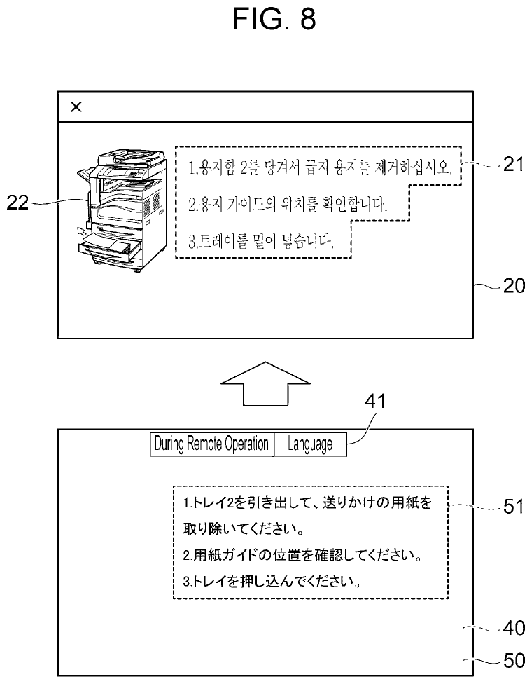

FIG. 8 illustrates a situation in which the mask screen that includes the second object that is written in the second language is superposed on the operation screen that includes the first object that is written in the first language.

As illustrated in FIG. 8, the operation screen 20 that is shared includes the object 21 that corresponds to the first object that is written in Korean as the first language and the object 22 of the image of the image processing apparatus 10 (see FIG. 1). Japanese is selected as the second language, and consequently, the operation button screen 40 that includes the operation button 41 and the mask screen 50 that includes the text object 51 that corresponds to the second object that is written in Japanese as the second language are superposed on the operation screen 20. Consequently, as illustrated in FIG. 7B described above, a screen on which instructions for operating are written in Japanese is displayed.

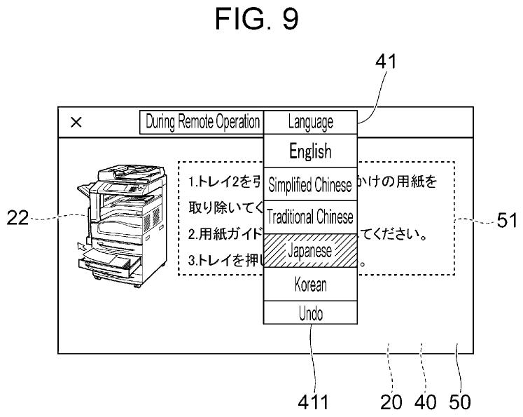

FIG. 9 illustrates a specific example of the clear button for clearing the mask screen that is displayed.

In the case where the predetermined time has passed after the mask screen is displayed or in the case where the clear button for clearing the mask screen that is displayed is pushed, the image processing apparatus 10 clears the mask screen that is displayed as described above. The aspect of the clear button for clearing the mask screen that is displayed is not particularly limited. As illustrated in, for example, FIG. 9, a clear button 411 on which words “Undo” are written may be displayed as the clear button for clearing the mask screen that is displayed. The mask screen 50 that is displayed is cleared in response to an operation of pushing the clear button 411. The mask screen 50 that is displayed is cleared, and consequently, the operation screen 20 the language setting of which is set at the first language is displayed again as illustrated, for example, in FIG. 7A described above.

### Other Exemplary Embodiments

The present exemplary embodiment is described above. However, the present disclosure is not limited to the exemplary embodiments described above. For example, the structure of the information processing system 1 illustrated in FIG. 1 and the hardware configuration of the image processing apparatus 10 illustrated in FIG. 2 are described by way of example and are not particularly limited. The functional configuration of the image processing apparatus 10 illustrated in FIG. 3 and the functional configuration of the remote terminal 30 illustrated in FIG. 4 are described by way of example and are not particularly limited. The information processing system 1 in FIG. 1 that has a function of performing the processing described above as a whole suffices. The functional configuration for fulfilling the function is not limited to the examples in FIG. 3 and FIG. 4.

The order of the steps of the processing of the image processing apparatus 10 illustrated in FIG. 5 and FIG. 6 is just an example and is not particularly limited. The steps may be performed chronologically in the order of the steps as illustrated or may be performed in parallel or individually without being performed chronologically. The specific examples illustrated in FIG. 7A to FIG. 9 are just examples and are not particularly limited.

For example, according to the exemplary embodiment described above by way of example, the information with which another user near the image processing apparatus 10 needs to deal is displayed as the user report information. However, the user report information is not limited thereto. In some cases, information with which another user near the image processing apparatus 10 does not need to deal, for example, is displayed as the user report information. In these cases, it is not necessary for the other user near the image processing apparatus 10 to understand the content of the user report information, and accordingly, the operation button for superposing the mask screen on the operation screen may not be displayed. Consequently, the operation button for superposing the mask screen on the operation screen is not displayed in the case where it is not necessary for the other user near the image processing apparatus 10 to understand the content and even in the case where the user report information is displayed on the operation screen that is shared. As a result, the other user near the image processing apparatus 10 is able to determine urgency and importance in the content of the user report information, based on whether the operation button is displayed.

FIG. 7A and FIG. 7B illustrate, by way of example, the mask screen 50 that includes the text object in which the instructions for operating are written in English, Chinese, Japanese, or Korean, but this is not a limitation. For example, another language other than English, Chinese, Japanese, and Korean may be selected. In this case, the mask screen DB 131 stores a mask screen that is written in the other language other than English, Chinese, Japanese, and Korean.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system includes: a processor or a plurality of processors configured to: generate a screen that includes a second object in which predetermined information is written in a second language, based on information about a first object in which the predetermined information is written in a first language, the first object being included in an operation screen of an image processing apparatus; and display an operation button for superposing the screen that includes the second object on the operation screen in response to displaying the operation screen that includes the first object on the image processing apparatus that is remotely operated.

(((2)))

As for the information processing system described in (((1))), the processor or the plurality of processors is configured to: generate the screen that includes the second object, based on a position of the first object that is displayed on the operation screen.

(((3)))

As for the information processing system described in (((2))), the processor or the plurality of processors is configured to: generate the screen that includes the second object, based on a character color and a background color of the first object on the operation screen.

(((4)))

As for the information processing system described in (((3))), the processor or the plurality of processors is configured to: generate the screen that includes the second object, based on a shape and a size of the first object on the operation screen.

(((5)))

As for the information processing system described in (((4))), the processor or the plurality of processors is configured to: place the second object at a position at which the second object entirely covers the first object when the screen that includes the second object is generated.

(((6)))

As for the information processing system described in any one of (((1))) to (((5))), the processor or the plurality of processors is configured to: manage the operation screen that includes the first object and the screen that includes the second object that is to be superposed on the operation screen in association with each other; and display the screen that includes the second object that is associated with the operation screen and that is superposed on the operation screen in response to an operation of pushing the operation button that is displayed.

(((7)))

As for the information processing system described in (((6))), the information that is written in the second language in the second object is information that is written in a language that is designated by a user who pushes the operation button.

(((8)))

As for the information processing system described in any one of (((1))) to (((7))), the processor or the plurality of processors is configured to: clear the screen that includes the second object that is displayed when a predetermined time has passed after the screen that includes the second object is displayed.

(((9)))

As for the information processing system described in (((8))), the processor or the plurality of processors is configured to: display a clear button for clearing the screen that includes the second object that is superposed on the operation screen and that is displayed; and clear the screen that includes the second object that is displayed in response to an operation of pushing the clear button even before the predetermined time has passed.

(((10)))

A program causing a computer to fulfil a function of: generating a screen that includes a second object in which predetermined information is written in a second language, based on information about a first object in which the predetermined information is written in a first language, the first object being included in an operation screen of an image processing apparatus; and displaying an operation button for superposing the screen that includes the second object on the operation screen in response to displaying the operation screen that includes the first object on the image processing apparatus that is remotely operated.

What is claimed is:

1. An information processing system comprising:
a processor or a plurality of processors configured to:
generate a screen that includes a second object in which predetermined information is written in a second language, based on information about a first object in which the predetermined information is written in a first language, the first object being included in an operation screen of an image processing apparatus; and
display an operation button for superposing the screen that includes the second object on the operation screen in response to displaying the operation screen that includes the first object on the image processing apparatus that is remotely operated.

2. The information processing system according to claim 1,
wherein the processor or the plurality of processors is configured to:
generate the screen that includes the second object, based on a position of the first object that is displayed on the operation screen.

3. The information processing system according to claim 2,
wherein the processor or the plurality of processors is configured to:
generate the screen that includes the second object, based on a character color and a background color of the first object on the operation screen.

4. The information processing system according to claim 3,
wherein the processor or the plurality of processors is configured to:
generate the screen that includes the second object, based on a shape and a size of the first object on the operation screen.

5. The information processing system according to claim 4,
wherein the processor or the plurality of processors is configured to:
place the second object at a position at which the second object entirely covers the first object when the screen that includes the second object is generated.

6. The information processing system according to claim 1,
wherein the processor or the plurality of processors is configured to:
manage the operation screen that includes the first object and the screen that includes the second object that is to be superposed on the operation screen in association with each other; and
display the screen that includes the second object that is associated with the operation screen and that is superposed on the operation screen in response to an operation of pushing the operation button that is displayed.

7. The information processing system according to claim 6,
wherein the information that is written in the second language in the second object is information that is written in a language that is designated by a user who pushes the operation button.

8. The information processing system according to claim 1,
wherein the processor or the plurality of processors is configured to:
clear the screen that includes the second object that is displayed when a predetermined time has passed after the screen that includes the second object is displayed.

9. The information processing system according to claim 8,
wherein the processor or the plurality of processors is configured to:
display a clear button for clearing the screen that includes the second object that is superposed on the operation screen and that is displayed; and
clear the screen that includes the second object that is displayed in response to an operation of pushing the clear button even before the predetermined time has passed.

10. A non-transitory computer readable medium storing a program causing a computer to fulfil a function of:
generating a screen that includes a second object in which predetermined information is written in a second language, based on information about a first object in which the predetermined information is written in a first language, the first object being included in an operation screen of an image processing apparatus; and
displaying an operation button for superposing the screen that includes the second object on the operation screen in response to displaying the operation screen that includes the first object on the image processing apparatus that is remotely operated.

11. A method comprising:
generating a screen that includes a second object in which predetermined information is written in a second language, based on information about a first object in which the predetermined information is written in a first language, the first object being included in an operation screen of an image processing apparatus; and
displaying an operation button for superposing the screen that includes the second object on the operation screen in response to displaying the operation screen that includes the first object on the image processing apparatus that is remotely operated.
